(19) United States
(12) Patent Application Publication
(10) Pub. No.: US 2004/0127822 A1
(43) Pub. Date: Jul. 1, 2004

(54) Hair care unit

(76) Inventor: David Eisenberg, Jerusalem (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 10/327,948

(22) Filed: Dec. 26, 2002

(51) Int. Cl. A61H 1/00

(52) U.S. Cl. 601/49

(57) ABSTRACT

A hair care unit comprising a hair care chair, a washing basin positioned with respect to said hair care chair so as to be adapted for washing thereat a head of a person sitting in said hair care chair, and a massage device positioned with respect to said hair care chair so as to be operative to massage a portion of the person sitting in said hair care chair other than the head of the person.

### FIELD OF THE INVENTION

The present invention relates generally to apparatus and methods for massage and shampooing during hair care, e.g., haircutting or hair styling.

### BACKGROUND OF THE INVENTION

An invigorating, manual scalp massage with shampooing is a common practice amongst many hairdressers and barbers. Devices for shampooing hair and massaging the scalp of a person are known. For example, Chinese Patent 1224597 describes a multifunctional bathing device that comprises a nozzle with a handle, two rolling brushes, several moving brushes and one miniature motor inside the casing of the nozzle. The motor and the rolling brushes are mounted inside a watertight inner chamber of the casing. A shaft extends from the motor and has an eccentric vibrating block, which drives the rolling brushes and the moving brushes. The nozzle has water spraying holes on both of its sides, and a massage head on the front side. Bathing liquid or shampoo may be added to the water channel of the device.

Another example is U.S. Pat. No. 5,116,253 to Charitar et al., which describes a hair shampoo stimulator device. Slightly curved zigzag supports are affixed to and extend across a frame, and firm bristles are affixed to and face downwardly on each support. A shampoo solution dispenser is mounted on the frame for dispensing the shampoo solution directly to a scalp of a person so that the bristles foam the shampoo solution and massage the scalp to stimulate the hair roots.

The previous examples are not hand-held. Hand-held applicators of shampoo and hair tonic that also incorporate massaging features are known. For example, U.S. Pat. No. 4,964,398 to Jones describes a shampoo or massage device that includes a pistol grip handle in which are disposed rechargeable batteries. A housing perpendicular to the handle includes partition walls providing a plurality of axially spaced cavities or compartments in which a dc motor, a gear reduction unit and a rotary-to-reciprocating conversion unit are mounted. The cavities housing the batteries, motor and gear reduction unit are sealed against the entry of moisture. A body engaging assembly or brush is mounted on the output of the rotary-to-reciprocating conversion unit and carries a plurality of fingers generally parallel to the housing axis.

Another example is U.S. Pat. No. 2,854,969 to Nolan, which describes a shampoo, massage and solution applying device for use in barber or beauty shops. The device may be used to apply a multiplicity of solutions to the hair and scalp, while at the same time massage the scalp.

### SUMMARY OF THE INVENTION

The present invention seeks to provide novel apparatus for hair care, such as but not limited to, shampooing and massaging patrons at a barber shop and the like, as is described more in detail hereinbelow.

The hair care unit of the invention may comprise different massage units, such as but not limited to, a head massage unit, a back massage unit, a shoulder massage unit and a foot massage unit. The head massage unit may wash, shampoo and massage the user's head/hair/scalp, and may even massage the neck. The shoulder, back and foot massage units may preferably massage the user's shoulder, back and feet areas. Any kind of massage technique may be carried out by the massage units, such as but not limited to, rolling massages, tapping massages, kneading massages and others.

Any and all aspects of the operation of the hair care unit may be controlled by a processor with a user-friendly interface. In this manner, the patron or barber may select the type of massage preferred, the duration and location of the massage, and which areas or combination of areas are to be massaged. For example, the feet may be massaged while the patron is being shampooed and having a neck massage. The invention may significantly enhance the barber/hairdresser/beauty salon (the terms being used interchangeably) experience.

In one embodiment of the invention, the hair care unit may comprise a shampoo chair, including a hair care chair and washing basin, wherein the hair care chair is also a massage chair incorporating one or more of the abovementioned massage units.

### BRIEF DESCRIPTION OF THE DRAWINGS

The present invention will be understood and appreciated more fully from the following detailed description taken in conjunction with the drawing in which:

FIG. 1 is a simplified pictorial illustration of a hair care unit, constructed and operative in accordance with an embodiment of the present invention;

FIG. 2 is a simplified pictorial illustration of the hair care unit with a head massage unit mounted in a washing basin, constructed and operative in accordance with an embodiment of the present invention;

FIG. 3 is a simplified pictorial illustration of the hair care unit with mounting arms of the head massage unit mounted outside of the washing basin, in accordance with an embodiment of the present invention;

FIGS. 4-6 are simplified illustrations of a foot massage unit for massaging the feet of a person, constructed and operative in accordance with an embodiment of the present invention, wherein FIG. 5 illustrates sole massage elements and toe massage elements, and FIG. 6 illustrates elements for massaging sides of the feet;

FIG. 7 is a simplified exploded illustration of a back massage unit for massaging the back, shoulders and chest of a person, constructed and operative in accordance with an embodiment of the present invention;

FIG. 8 is a simplified exploded illustration of shoulder or upper torso massage units, constructed and operative in accordance with an embodiment of the present invention;

FIGS. 9-11 are simplified pictorial illustrations of the back massage unit of FIG. 7, with provision for mounting on the back of a chair (FIG. 10) and for folding about an axis (FIG. 11);

FIG. 12 is a simplified pictorial illustration of roller elements of massage elements of the back massage unit of FIG. 7, in accordance with an embodiment of the present invention;

FIG. 13 is a simplified pictorial illustration of imparting motion to the massage elements of the back massage unit of FIG. 7, in accordance with an embodiment of the present invention;

FIGS. 14A and 14B are simplified pictorial illustrations of adjusting the distance between massage elements of the back massage unit of FIG. 7, in accordance with an embodiment of the present invention; and

FIG. 15 is a simplified exploded illustration of a back massage unit for massaging the back, shoulders and chest of a person, constructed and operative in accordance with another embodiment of the present invention.

### DETAILED DESCRIPTION OF THE PREFERRED EMBODIMENT

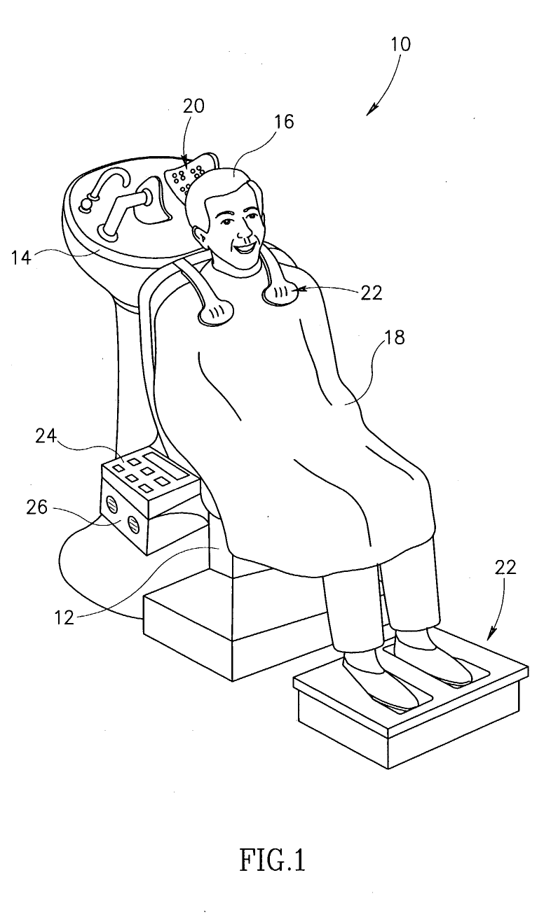

Reference is now made to FIG. 1, which illustrates a hair care unit 10, constructed and operative in accordance with an embodiment of the present invention.

Hair care unit 10 may comprise a hair care chair 12 and a washing basin 14 positioned with respect to hair care chair 12 so as to be adapted for washing thereat a head 16 of a person 18 sitting in hair care chair 12. In one embodiment of the invention, washing basin 14 may be provided separately from hair care chair 12. In another embodiment of the invention, washing basin 14 may be provided together with hair care chair 12, forming what is generally referred to in the art as a shampoo chair. Washing basin 14 may comprise a stationary basin or a tiltable or movable basin, for example.

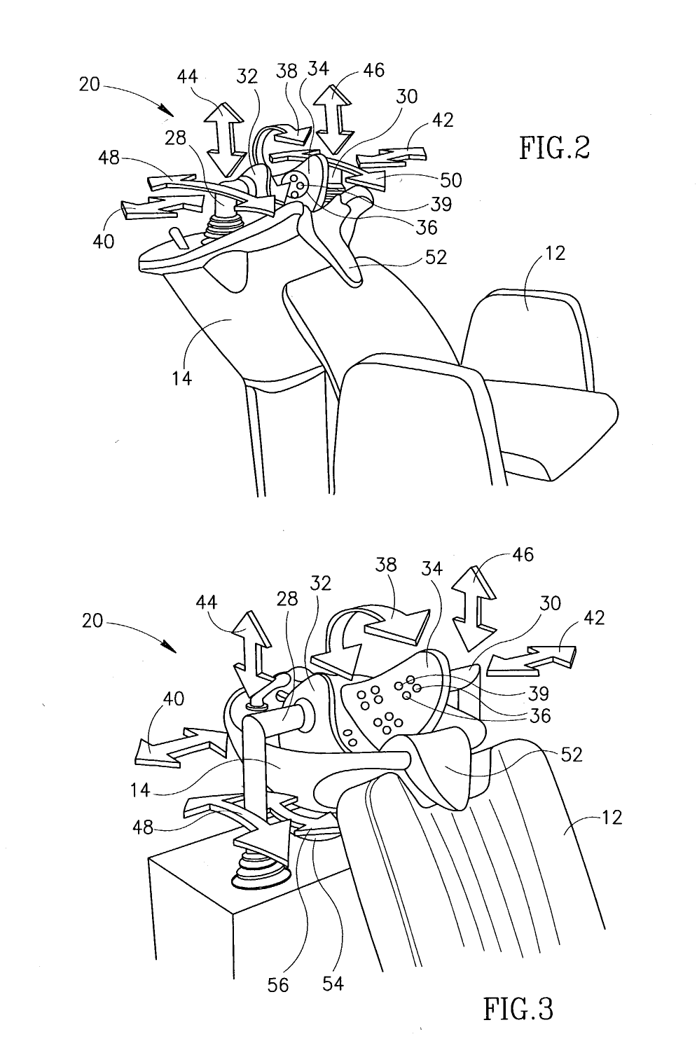

In one embodiment of the invention, a head massage unit 20 is mounted in washing basin 14, forming an integral basin/massage unit, described more in detail hereinbelow with reference to FIGS. 2 and 3.

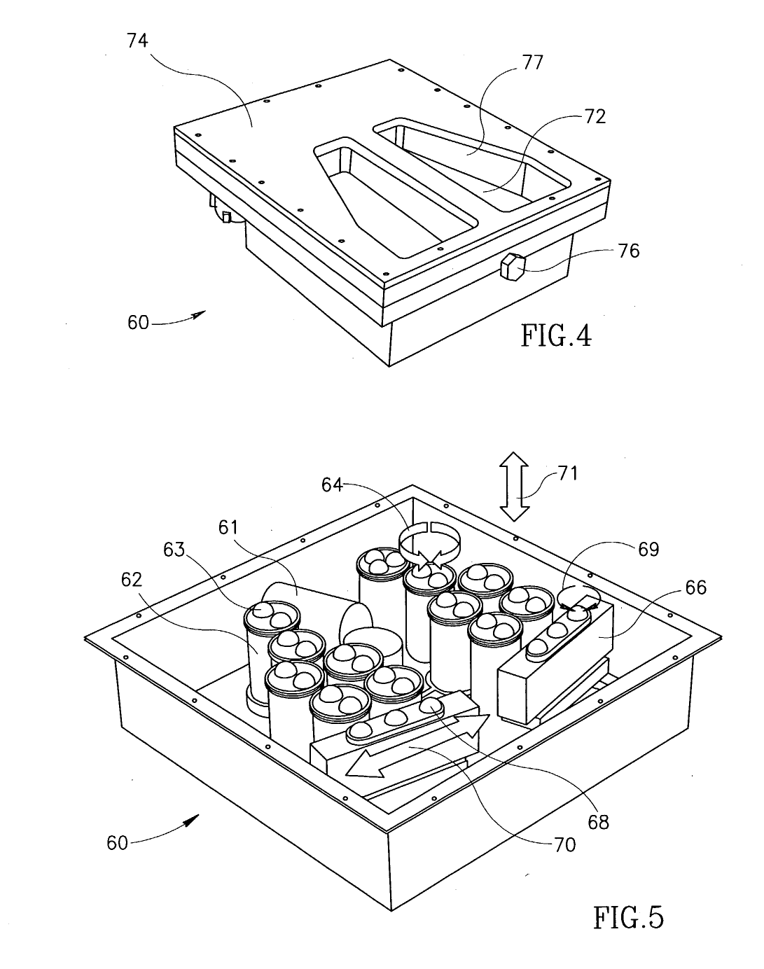

One or more massage devices 22 may be positioned with respect to hair care chair 12 for massaging other portions of the person 18 sitting in hair care chair 12 other than the head 16. Examples of massage devices 22 are described more in detail hereinbelow with reference to FIGS. 4-15.

Hair care unit 10 may also comprise a controller 24, which may control some characteristic of operation of massage device 22 and/or head massage unit 20. Controller 24 is illustrated as a console unit extending from hair care chair 12 or the base of washing basin 14, but it is appreciated that the invention is not limited to this type of controller, and controller 24 may also comprise a remote control device, PC or any other user-friendly interface. Controller 24 may control characteristics, such as but not limited to, massage intensity (e.g., massage strokes that press harder on the body, or more soothing, gentle massage strokes), massage type (e.g., shiatsu, kneading, rolling, chopping, etc.), massage direction (e.g., up/down, sideways, circular, curvilinear, etc.), and operations on head 16 in addition to massaging, e.g., washing, shampooing, and/or rinsing. In this manner, the person 18 or barber (not shown) may select the type of massage preferred, the duration and location of the massage, and which areas or combination of areas are to be massaged. For example, the feet may be massaged while the person 18 is being shampooed and having a neck massage.

Audio apparatus 26 may be provided for producing audible sounds, such as but not limited to, music for enhancing the soothing and healthful benefits of the massage, and making the entire session at the barber shop more enjoyable. Audio apparatus 26 may comprise, without limitation, headphones, stereo equipment, CD players, etc, and may or may not be built-in with hair care chair 12, washing basin 14 or any other element of hair care unit 10.

Reference is now made to FIG. 2, which illustrates more detail of the head massage unit 20 mounted in washing basin 14, in accordance with an embodiment of the present invention. Washing basin 14 may comprise two or more adjustable mounting arms 28 and 30, on which massage mechanisms 32 and 34, respectively, may be mounted. Massage mechanisms 32 and 34 may comprise a plurality of massage elements 36, which may rotate in generally circular movements, as indicated by arrow 38. Any number, size and shape of massage elements 36 may be provided. One or more of the massage elements 36 (as indicated by reference numeral 39 in FIG. 2) may be used to pump therethrough substances, such as but not limited to, water, shampoo, conditioner, toner, dyes, dye removers, etc.

Adjustable mounting arms 28 and 30 may be moved or adjusted with respect to washing basin 14 in a number of directions. For example, each mounting arm 28 and 30 may be moved independently of the other arm sideways, as indicated by arrows 40 and 42, and/or in an up/down direction, as indicated by arrows 44 and 46, and/or in a front/back direction, as indicated by arrows 48 and 50. Accordingly, any portion of the head or scalp 16 of person 18 may be massaged with massage mechanisms 32 and 34. One of the possible massage devices for massaging non-head portions of the person 18 is shown in FIG. 2, namely, a neck massage unit 52, which may be mounted on a front portion of washing basin 14, such as where the person's head 16 lies in the washing basin 14. (The person 18 is omitted from FIG. 2 for clarity.)

Reference is now made to FIG. 3, which illustrates more detail of the head massage unit 20 mounted with respect to washing basin 14, in accordance with another embodiment of the present invention. The embodiment of FIG. 3 is similar to that of FIG. 2, and like elements are designated with like numerals. One difference between the embodiments of FIGS. 2 and 3 is that in the embodiment of FIG. 3, adjustable mounting arms 28 and 30 are mounted outside washing basin 14. The operational principle of the massage mechanisms 32 and 34 may be identical to that of the embodiment of FIG. 2. Another feature of the embodiment of FIG. 3 is that washing basin 14 may be pivotally mounted with respect to hair care chair 12 on a ball joint 54, which permits moving or turning washing basin 14 in a direction indicated by arrow 56.

Reference is now made to FIGS. 4-6, which illustrate one of the massage devices for massaging parts of the body other than the head, a foot massage unit 60 for massaging the feet.

In accordance with an embodiment of the present invention, foot massage unit 60 may comprise sole massage elements 62 for massaging the sole of the foot. Sole massage elements 62 may comprise a plurality of rollers 63, such as but not limited to, 12 sets of two rollers per element, which may rotate as indicated by arrow 64, as illustrated in FIG. 5. Additionally or alternatively, foot massage unit 60 may comprise toe massage elements 66 for massaging the toes. Toe massage elements 66 may comprise a plurality of sliding/rolling massagers 68, such as but not limited to, two sets of three massagers, which may rotate and slide as indicated by arrows 69 and 70, respectively, as illustrated in FIG. 5. Sole massage elements 62 and toe massage elements 66 may be spring-mounted for biasing movement up and down, as indicated by arrow 71. A motor 61 may actuate and control motion of the massage elements and their rollers. Different vibration speeds may be provided to enable different kinds of massages on the sole and toes.

Referring to FIG. 4, foot massage unit 60 may comprise two cavities 72 in which feet may be placed. The upper surface of foot massage unit 60 may be covered with a washable textile cover 74. Foot massage unit 60 may be adjustable for different foot sizes, such as (but not limited) by means of a turning knob 76. One or more heating elements 77 may be provided for warming the feet during massage.

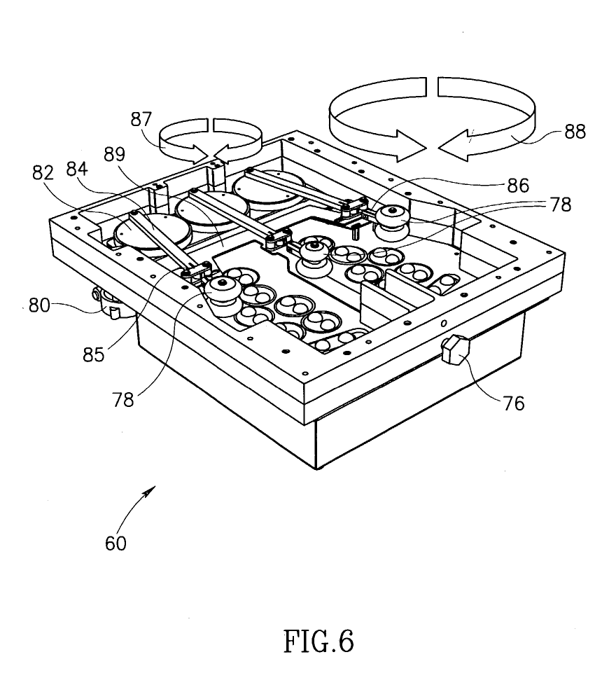

FIG. 6 illustrates another option of the foot massage unit 60 for massaging sides of the feet, in accordance with an embodiment of the present invention. A plurality of massage rollers 78, such as but not limited to, three massage rollers 78, may be provided. In the illustrated embodiment, the massage rollers 78 are spaced such that each foot may be placed between a pair of rollers 78, wherein the middle roller 78 serves to massage the medial (inner) sides of both feet and the two outer rollers 78 massage the lateral (outer) side of each individual foot.

The massage rollers 78 may be driven (rotated) by means of a motor 80. Motor 80 may be linked to massage rollers 78 by means of a gearing mechanism 82 and a crank arm 84. Each massage roller 78 may be connected to its respective crank arm 84 by means of a spring-loaded mounting interface 86 that connects the roller 78 to a slider mechanism 85. Rotation of gearing mechanism 82 in the direction indicated by arrow 87 causes massage rollers 78 to move in an elliptical movement, indicated by arrow 88, due to motion of crank arm 84 and slider mechanism 85. The spring-loaded mounting interface 86 may ensure that massage rollers 78 contact the foot properly during the massage and maintain the elliptical movement.

The side massage may be adjusted for different foot sizes by changing the position of the slider mechanism 85. The position of slider mechanism 85 may be controlled by turning knob 76, which may be linked to a slider bracket 89, which adjusts the position of the slider mechanism 85. Different slider positions may result in different elliptical motions.

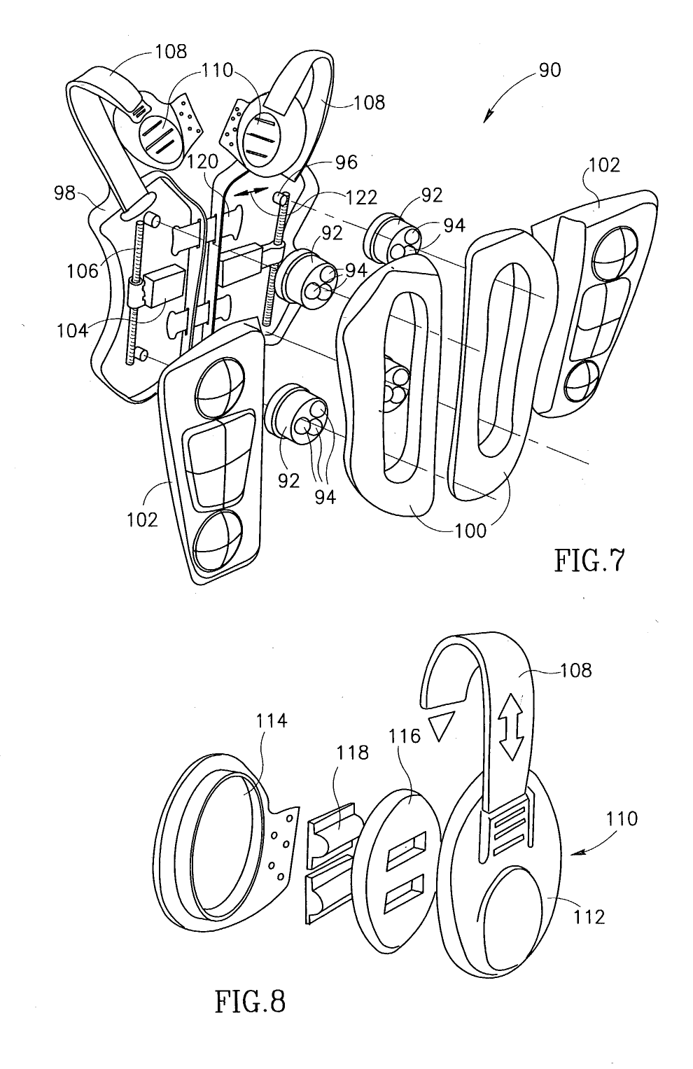

Reference is now made to FIG. 7, which illustrates another of the massage devices for massaging parts of the body other than the head, a back massage unit 90 for massaging the back, shoulders and chest.

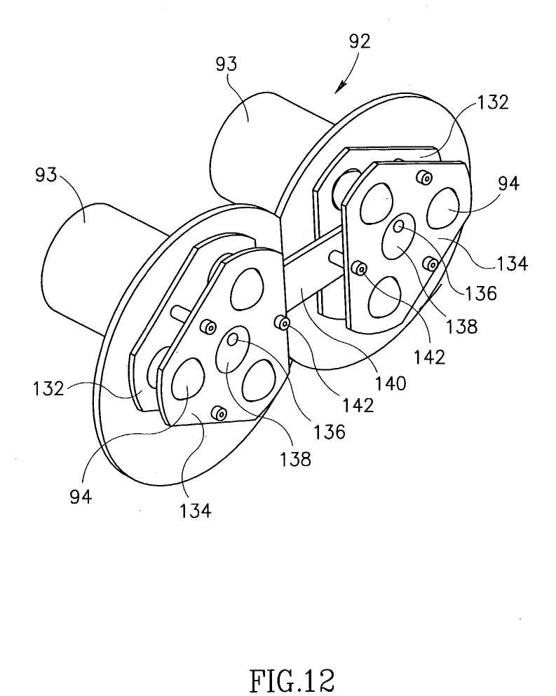

In accordance with an embodiment of the present invention, back massage unit 90 may comprise one or more massage elements 92, which may comprise a plurality of roller elements 94. In the illustrated embodiment, there are four massage elements 92 (although the invention is not limited to this number) mounted for rotation on spindles 96. Each massage element 92 may comprise a motor 93 (not shown in FIG. 7, but shown in FIG. 12 further below) for rotating or otherwise moving (e.g., reciprocating motion) roller elements 94. Spindles 96 may be mounted on a jacket shell 98, which may be made of any suitable material, such as but not limited to, plastic, fabric or leather. Back massage unit 90 may further comprise foam padding members 100 and padded shell elements 102, which assemble together with jacket shell 98 and the inner elements to form the complete unit. Depending on how the complete unit is worn, massage elements 92 may either massage the back of the person or the chest or torso of the person.

Back massage unit 90 may further comprise additional massage elements, such as but not limited to, a pair of roller or pulsating massage elements 104, which may be slidingly mounted on threaded rods 106 attached to jacket shell 98.

Back massage unit 90 may further comprise shoulder straps 108 on which are mounted shoulder or upper torso massage units 110, which are shown more in detail in FIG. 8. Massage unit 110 may comprise an outer shell 112 and a complementary shell 114 which snap fit together, or may be assembled together in any other convenient manner. Disposed between the shells 112 and 114 may be a foam pad 116 and one or more roller or pulsating massage elements 118. The massage element 118 may be spring-loaded to maintain tension against the shoulder or upper torso of the person. Depending on how the complete unit is worn, massage unit 110 may alternatively be used to massage the shoulder blades as well.

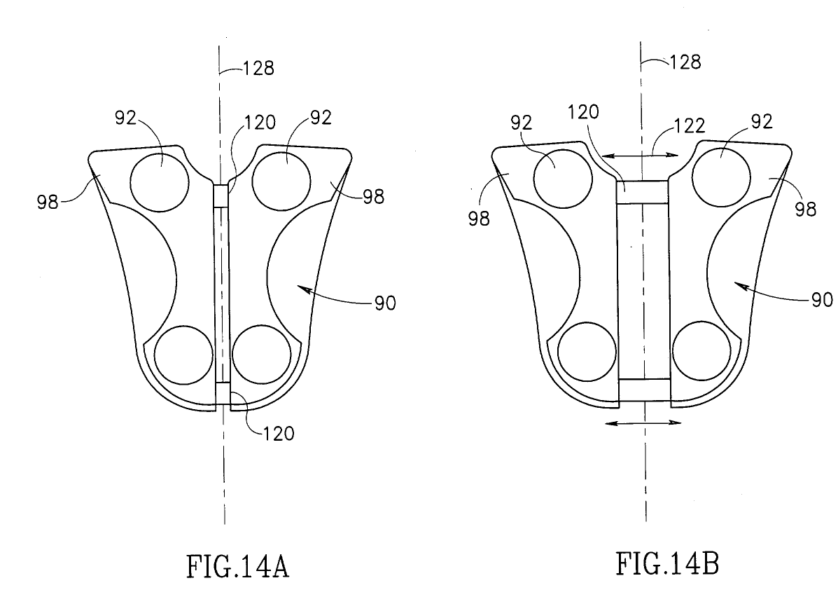

Referring again to FIG. 7, it is seen that jacket element 98 may comprise two halves connected by straps 120. The two halves of jacket element 98 may be moved sideways as indicated by arrow 122. In this manner, the distance between massage elements 92 may be adjusted, as further illustrated in FIGS. 14A and 14B. Besides allowing massage elements 92 to be adjusted for each individual user, the distance adjustment may help avoid undesired massaging close to the spinal cord.

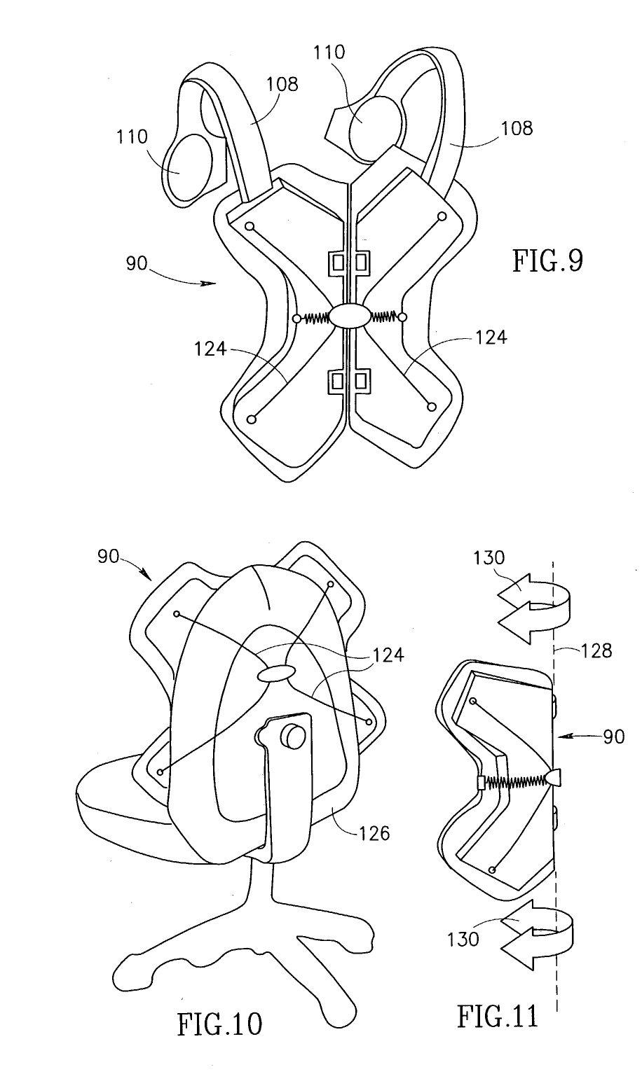

Reference is now made to FIGS. 9-11. Back massage unit 90 may be a separate unit from hair care chair 12 (FIG. 1). Back massage unit 90 may comprise flexible, elastic straps 124, so that back massage unit may be attached to the back of any chair 126 (FIG. 10). As seen in FIG. 11, back massage unit 90 may be folded about an axis 128, as indicated by arrows 130, thus making the unit adaptable to any size or shape of person. It is noted that alternatively, back massage unit 90 may be built into hair care chair 12 (FIG. 1).

Reference is now made to FIG. 12, which illustrates roller elements 94 of massage elements 92 more in detail, although the invention is not limited to this construction. As mentioned above, motor 93 may rotate or otherwise move (e.g., in reciprocating motion) roller elements 94. Roller elements 94 may comprise balls mounted between a pair of plates 132 and 134. Rotation of a shaft 136 of motor 93 may impart motion to plates 132 and 134 by means of an eccentric mass 138. Thus, the circular rotation of shaft 136 is translated into eccentric massaging movement of plates 132 and 134 and roller elements 94. Plates 132 and 134 may be connected by a flexible connecting member 140 fixed at attachment points 142, in which case both sets of roller elements 94 move together in their massaging movement.

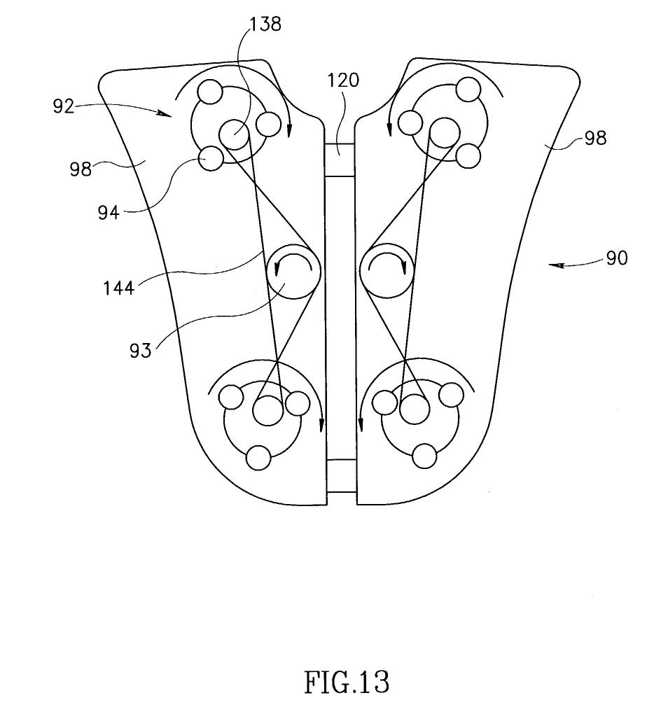

Reference is now made to FIG. 13, which illustrates yet another method of imparting motion to roller elements 94 of massage elements 92. In this embodiment, one motor 93 may rotate the eccentric masses 138 of two sets of roller elements 94 by means of a gear belt or timing belt 144.

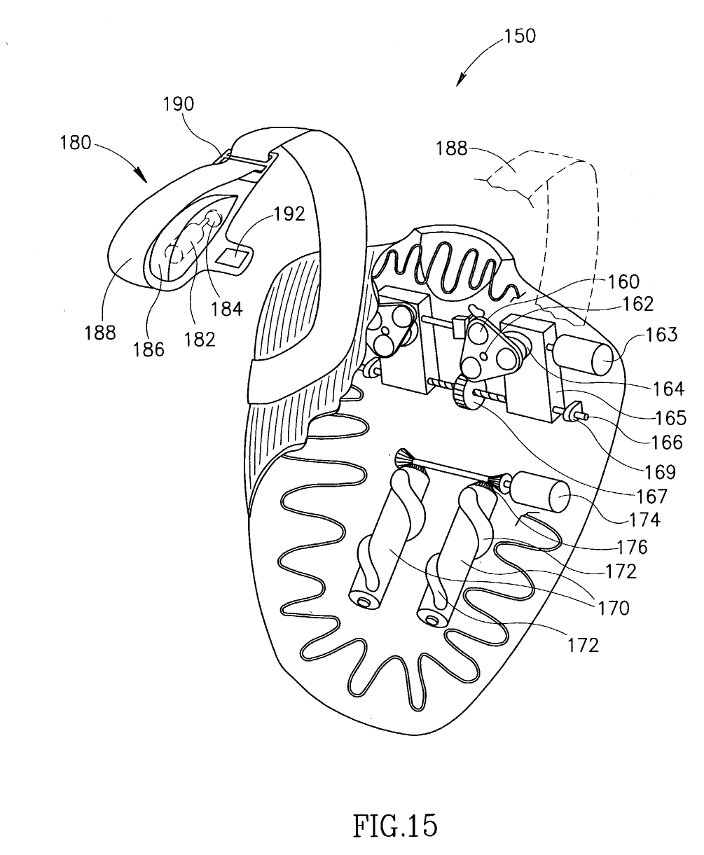

Reference is now made to FIG. 15, which illustrates yet another back massage unit 150 for massaging the back, shoulders and chest.

In accordance with an embodiment of the present invention, back massage unit 150 may comprise a shoulder massage elements 160, back massage elements 170 and torso (e.g., the upper torso in the breast area) massage elements 180.

Shoulder massage elements 160 may comprise one or more sets of rollers (two sets of three rollers are illustrated) rotatably mounted on a crank 162 and driven by a motor 163 through a gear train 164. A housing 165 of each gear train 164 may be slidingly and threadedly mounted on a threaded shaft 166, wherein suitable rotation of a thumbwheel 167 may adjust the distance between shoulder massage elements 160 to suit the particular user. The pressure of the massage may be regulated with an adjustment device 169, which adjust the forward and backward position of the shoulder massage elements with respect to an outer shell 152 of back massage unit 150.

Back massage elements 170 may comprise one or more sets of rollers (two sets of rollers are illustrated) symmetrically arranged about a spine of a user. Each back massage element 170 may comprise a semi-rigid spire 172, which provides a longitudinal massage movement during rotation of back massage element 170. Back massage elements 170 may be driven by a motor 174 by means of a worm gear train 176.

Torso massage element 180 may comprise a motor 182 with an eccentric mass 184 mounted on the motor shaft and housed in an enclosure 186, such as but not limited to, a foamed plastic enclosure. Torso massage element 180 may be attached to a strap 188 and adjusted with a buckle 190. A VELCRO patch 192 may be provided for connecting to clothing or any other suitable object.

Outer shell 152 may comprise a heater 194, such as but not limited to, a built-in electrical resistance heater, for heating portions of the person's body, e.g., the back, shoulder and neck. A thermostat 196 may be provided for safeguarding the system against overheating. All electrical systems may be low voltage in order to meet applicable regulations.

It is appreciated that hair care unit 10 may comprise other kinds of massage devices. For example, in accordance with one embodiment of the invention, hair care unit 10 may comprise a massage chair coupled with basin 14 and head massage unit 20.

It is also appreciated that hair care unit 10 described hereinabove, in accordance with another embodiment of the present invention, may comprise a retrofit unit that converts a standard hair care chair or shampoo chair into a shampoo/barber/massage system.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art:

What is claimed is:

1. A hair care unit comprising:
a hair care chair;
a washing basin positioned with respect to said hair care chair so as to be adapted for washing thereat a head of a person sitting in said hair care chair; and
a massage device positioned with respect to said hair care chair so as to be operative to massage a portion of the person sitting in said hair care chair other than the head of the person.

2. The hair care unit according to claim 1, further comprising a head massage unit.

3. The hair care unit according to claim 2, wherein mounting arms of said head massage unit are mounted inside said washing basin.

4. The hair care unit according to claim 2, wherein mounting arms of said head massage unit are mounted outside said washing basin.

5. The hair care unit according to claim 1, wherein said massage device is built into said hair care chair.

6. The hair care unit according to claim 1, wherein said massage device comprises a device external to said hair care chair and placeable in massaging relationship with a person sitting in said hair care chair.

7. The hair care unit according to claim 1, wherein said massage device comprises at least one of a shoulder massage unit, a back massage unit, a foot massage unit, and a torso massage unit.

8. The hair care unit according to claim 2, further comprising a controller adapted to control a characteristic of operation of at least one of said massage device and head massage unit, said characteristic of operation comprising at least one of a massage intensity, a massage type, and a massage direction.

9. The hair care unit according to claim 2, further comprising a heater adapted to heat an area being massaged by at least one of said massage device and head massage unit.

10. The hair care unit according to claim 2, wherein at least one of said massage device and head massage unit comprises a plurality of spaced massage elements whose distance therebetween is adjustable.

11. The hair care unit according to claim 1, further comprising audio apparatus capable of producing audible sounds.

12. The hair care unit according to claim 1, wherein said massage device comprises at least one massage element through which a substance is pumpable.

13. The hair care unit according to claim 1, wherein said washing basin is pivotally mounted with respect to said hair care chair.

14. The hair care unit according to claim 7, wherein said foot massage unit comprises at least one of sole massage elements, toe massage elements and massage rollers for massaging sides of a foot.

15. The hair care unit according to claim 7, wherein said back massage unit comprises two halves connected by a strap, a distance between the two halves being adjustable.

16. The hair care unit according to claim 7, wherein said back massage unit is attachable to a chair.

17. The hair care unit according to claim 7, wherein said back massage unit is foldable about an axis.
